(19) United States
(12) Patent Application Publication
(10) Pub. No.: US 2026/0358130 A1
(43) Pub. Date: Nov. 12, 2026

(54) METHOD FOR DETERMINING A FINAL LOCATION SUGGESTION FOR AN ELECTRIC VEHICLE

(71) Applicant: GM Global Technology Operations LLC, Detroit, MI (US)

(72) Inventors: Ryan Patrick Hickey, New York, NY (US); Russell A. Patenaude, Macomb Township, MI (US); Matthew Edward Gilbert-Eyres, Rochester Hills, MI (US); David R. Clark, Grosse Pointe Woods, MI (US)

(21) Appl. No.: 19/205,048

(22) Filed: May 12, 2025

(51) Int. Cl. G01C 21/34; B60L 58/10; G01C 21/36

(52) U.S. Cl. CPC G01C 21/3461; B60L 58/10; G01C 21/3602; G01C 21/3647; G01C 21/3679; G01C 21/3691; B60L 2240/545; B60L 2240/662

(57) ABSTRACT

A method for determining a final location suggestion for an electric vehicle includes a plurality of steps. The first step is measuring an ambient environmental temperature of an initial location of the electric vehicle and determining that the ambient environmental temperature falls outside of a minimum acceptable environmental temperature and a maximum acceptable environmental temperature. The second step is determining that the initial location is not one of a plurality of private structures, but one of a plurality of enclosed public structures. The third step is measuring an ambient vehicle temperature of the electric vehicle and determining that the ambient vehicle temperature falls outside of a minimum acceptable vehicle temperature and a maximum acceptable vehicle temperature. Finally, a final location suggestion is determined based on data received by a plurality of sensors in the electric vehicle and the final location suggestion is indicated to a user of the electric vehicle.

### INTRODUCTION

The present disclosure relates to determining a final location suggestion for an electric vehicle.

Electric vehicles utilize electric vehicle batteries to receive and store electrical energy, releasing the electrical energy while in operation to power the electric vehicle. The electric vehicle has a projected range distance, which is a maximum distance the electric vehicle may operate. Typically, an electric vehicle controller calculates the amount of electrical energy stored in the electric vehicle’s battery to determine the maximum distance the electric vehicle may travel. The electric vehicle also has a charging efficiency, which is a percentage of electrical energy the electric vehicle’s battery may receive relative to the electrical energy discharged from a charging station while the electric vehicle is charging. The projected range distance and the charging efficiency of the electric vehicle may be adversely impacted by environmental factors surrounding the electric vehicle, such as temperature, while the electric vehicle is parked.

Thus, while current electric vehicle batteries and charging stations achieve their intended purpose, there is a need for a new and improved system and method for determining a charging location for an electric vehicle that has the environment to achieve the projected range distance and maximum charging efficiency of the electric vehicle.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for providing a charging location for a parked electric vehicle. The method also includes measuring a current environmental temperature of a first location of the parked electric vehicle using a plurality of vehicle sensors in the parked electric vehicle; comparing the current environmental temperature to a minimum acceptable environmental temperature and a maximum acceptable environmental temperature of an electric vehicle battery in the parked electric vehicle; determining the current environmental temperature of the first location is one of less than the minimum acceptable environmental temperature and is higher than the maximum acceptable environmental temperature; collecting a plurality of positional and visual data of the first location using the plurality of vehicle sensors; determining the first location is not one of a plurality of private structures having a plurality of private structure sides associated with the parked electric vehicle based on the plurality of positional and visual data; determining the first location is one of a plurality of enclosed public structures based on the plurality of positional and visual data; measuring a vehicle temperature of the parked electric vehicle using the plurality of vehicle sensors; comparing the vehicle temperature to a minimum acceptable vehicle temperature and a maximum acceptable vehicle temperature of the electric vehicle battery; determining the vehicle temperature of the first location is one of less than the minimum acceptable vehicle temperature and is higher than the maximum acceptable vehicle temperature; determining the first location of the parked electric vehicle is not a preferred location for the parked electric vehicle based on the determination that current environmental temperature of the first location is one of lower than the minimum acceptable environmental temperature and is higher than the maximum acceptable environmental temperature, the determination that the first location is not a private structure associated with the parked electric vehicle, the determination that the first location is a public structure, and the determination that the vehicle temperature of the parked electric vehicle is one of less than the minimum acceptable vehicle temperature and higher than the maximum acceptable vehicle temperature; determining a second location is the charging location for the parked electric vehicle using the plurality of vehicle sensors; and providing the charging location for the parked electric vehicle. Other embodiments of this aspect include corresponding computer systems, apparatus, and computer programs recorded on one or more computer storage devices, each configured to perform the actions of the methods.

Implementations may include one or more of the following features. The method where measuring the current environmental temperature of the first location of the parked electric vehicle using the plurality of vehicle sensors further may include measuring the current environmental temperature of the first location of the parked electric vehicle using the plurality of vehicle sensors having a plurality of temperature sensors. Comparing the current environmental temperature to the minimum acceptable environmental temperature and the maximum acceptable environmental temperature of the electric vehicle battery further may include comparing the current environmental temperature to the minimum acceptable environmental temperature when the minimum acceptable environmental temperature is 20 degrees Celsius and comparing the current environmental temperature to the maximum acceptable environmental temperature when the maximum acceptable environmental temperature is 45 degrees Celsius. Collecting the plurality of positional and visual data of the first location using the plurality of vehicle sensors further may include collecting the plurality of positional and visual data of the first location using the plurality of vehicle sensors having a location sensor and a plurality of cameras. The method may include determining the first location is similar to a location of one of the plurality of private structures associated with the parked electric vehicle when the location sensor identify the first location as being similar to a location of one of the plurality of private structures associated with the parked electric vehicle. The method may include determining the first location is similar to one of the plurality of private structures associated with the parked electric vehicle when the plurality of cameras identify the first location as belonging to one of the plurality of private structures associated with the parked electric vehicle. The at least one of the plurality of private structure sides that has not been identified has a structure door having a closed state and an open state. The method may include indicating that the structure door is in the open state and that setting the structure door to the closed state will maintain a maximum charging efficiency of the parked electric vehicle via a human-machine interface connected to the parked electric vehicle while charging the parked electric vehicle. The method may include determining that the one of the plurality of private structures associated with the parked electric vehicle is enclosed based on determining that each of the plurality of private structure sides has been identified by the plurality of cameras. Determining the first location is not one of the plurality of private structures associated with the parked electric vehicle based on the plurality of positional and visual data further may include determining that the first location is not similar to a location of one of the plurality of private structures associated with the parked electric vehicle when the location sensor do not identify the first location as being similar to a location of one of the plurality of private structures associated with the parked electric vehicle. Determining the first location is one of the plurality of enclosed public structures based on the plurality of positional and visual data further may include determining that the first location is not similar to a location of one of the plurality of private structures associated with the parked electric vehicle when the location sensor do not identify the first location as being similar to a location of one of the plurality of private structures associated with the parked electric vehicle and determining that the first location is enclosed when the location sensor identify the first location as being one of a plurality of enclosed public structures or determining that each of a plurality of public structure sides has been identified by the plurality of cameras. Comparing the vehicle temperature to the minimum acceptable vehicle temperature and the maximum acceptable vehicle temperature of the electric vehicle battery further may include comparing the vehicle temperature to the minimum acceptable vehicle temperature when the minimum acceptable vehicle temperature is 20 degrees Celsius and comparing the vehicle temperature to the maximum acceptable vehicle temperature when the maximum acceptable vehicle temperature is 45 degrees Celsius. Determining the first location of the parked electric vehicle is not the preferred location for the parked electric vehicle further may include indicating that the current environmental temperature and the vehicle temperature are not preferred conditions for maintaining an electric vehicle range distance of the parked electric vehicle via a human-machine interface connected to the parked electric vehicle. Determining the first location of the parked electric vehicle is not a preferred final location for the parked electric vehicle further may include indicating that the current environmental temperature and the vehicle temperature are not conditions for maintaining a maximum charging efficiency of the parked electric vehicle via a human-machine interface connected to the parked electric vehicle while charging the parked electric vehicle. Determining the charging location using the plurality of vehicle sensors further may include determining the charging location based on a position of the charging location within one of the plurality of public enclosed structures using the plurality of vehicle sensors. The method may include receiving a final location ambient temperature of the position of the charging location from a cloud interface connected to the parked electric vehicle. The method may include comparing the current environmental temperature to the final location ambient temperature. The method may include determining the charging location based on a determination that the current environmental temperature is within five degrees Fahrenheit of the final location ambient temperature. Implementations of the described techniques may include hardware, a method or process, or computer software on a computer-accessible medium.

One general aspect includes a method for indicating that setting a structure door of one of a plurality of private structures having a closed state and an open state to the closed state can maintain a maximum charging efficiency of a parked electric vehicle. The method also includes measuring a current environmental temperature of a first location of the parked electric vehicle using a plurality of vehicle sensors in the parked electric vehicle; comparing the current environmental temperature to a minimum acceptable environmental temperature and a maximum acceptable environmental temperature of an electric vehicle battery in the parked electric vehicle, determining the current environmental temperature of the first location is either lower than the minimum acceptable environmental temperature or is higher than the maximum acceptable environmental temperature, collecting a plurality of positional and visual data of the first location using the plurality of vehicle sensors where collecting the plurality of positional and visual data of the first location using the plurality of vehicle sensors may include collecting the plurality of positional and visual data of the first location using the plurality of vehicle sensors having a location sensor and a plurality of cameras, determining the first location is similar to a location of one of the plurality of private structures associated with the parked electric vehicle when the location sensor identify the first location as being similar to a location of one of the plurality of private structures associated with the parked electric vehicle, determining that the structure door is in the open state based on the structure door not being identified as being in the closed state by the plurality of cameras, and indicating that setting the structure door to the closed state can maintain the maximum charging efficiency of the parked electric vehicle via a human-machine interface connected to the parked electric vehicle. Other embodiments of this aspect include corresponding computer systems, apparatus, and computer programs recorded on one or more computer storage devices, each configured to perform the actions of the methods.

One general aspect includes a method for providing a second location for a parked electric vehicle that maintains an electric vehicle range distance of the parked electric vehicle. The method also includes measuring a current environmental temperature of a first location of the parked electric vehicle using a plurality of temperature sensors in the parked electric vehicle; comparing the current environmental temperature to a minimum acceptable environmental temperature and a maximum acceptable environmental temperature of an electric vehicle battery in the parked electric vehicle where the minimum acceptable environmental temperature is 20 degrees Celsius, the maximum acceptable environmental temperature is 45 degrees Celsius, and the electric vehicle battery powers the parked electric vehicle for the electric vehicle range distance; determining the current environmental temperature of the first location is either lower than the minimum acceptable environmental temperature or is higher than the maximum acceptable environmental temperature; collecting a plurality of positional and visual data of the first location using a location sensor and a plurality of cameras in the parked electric vehicle; determining the first location is not one of a plurality of private structures associated with the parked electric vehicle based on the plurality of positional and visual data; determining the first location is one of a plurality of enclosed public structures based on the plurality of positional and visual data by determining that the first location is not similar to a location of one of the plurality of private structures associated with the parked electric vehicle when the location sensor do not identify the first location as being similar to a location of one of the plurality of private structures associated with the parked electric vehicle and determining that the first location is enclosed when the location sensor identify the first location as being one of a plurality of enclosed locations or determining that each of a plurality of public structure sides has been identified by the plurality of cameras; measuring a vehicle temperature of the parked electric vehicle using the plurality of temperature sensors; comparing the vehicle temperature to a minimum acceptable vehicle temperature and a maximum acceptable vehicle temperature of the electric vehicle battery where the minimum acceptable vehicle temperature is 20 degrees Celsius and the maximum acceptable vehicle temperature is 45 degrees Celsius; determining the vehicle temperature of the parked electric vehicle is either lower than the minimum acceptable vehicle temperature or is higher than the maximum acceptable vehicle temperature; determining the first location of the parked electric vehicle does not maintain the electric vehicle range distance based on the determination that current environmental temperature of the first location is either lower than the minimum acceptable environmental temperature or is higher than the maximum acceptable environmental temperature, the determination that the first location is not one of the plurality of private structures associated with the parked electric vehicle, the determination that the first location is an enclosed public structure, and the determination that the vehicle temperature of the first location is either lower than the minimum acceptable vehicle temperature or is higher than the maximum acceptable vehicle temperature; indicating the current environmental temperature and the vehicle temperature are not preferred conditions for maintaining the electric vehicle range distance via a human-machine interface connected to the parked electric vehicle; determining the second location for the parked electric vehicle that maintains the electric vehicle range distance using the location sensor and the plurality of cameras based on a position of the second location within one of the plurality of public enclosed structures and one of a final location environmental temperature of the second location within the public enclosed structure; and providing the second location for the parked electric vehicle that maintains the electric vehicle range distance via the human-machine interface connected to the parked electric vehicle. Other embodiments of this aspect include corresponding computer systems, apparatus, and computer programs recorded on one or more computer storage devices, each configured to perform the actions of the methods.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a system for determining a final location suggestion for an electric vehicle within one of a plurality of enclosed public structures according to an exemplary embodiment;

FIG. 2 is a schematic diagram of a system for determining a final location suggestion for an electric vehicle within one of a plurality of private structures according to an exemplary embodiment;

FIG. 3A is a first part of a flowchart demonstrating a method for determining the final location suggestion for the electric vehicle according to an exemplary embodiment; and

FIG. 3B is a second part of a flowchart demonstrating a method for determining the final location suggestion for the electric vehicle according to an exemplary embodiment.

### DETAILED DESCRIPTION

The following description is merely exemplary in nature and is not intended to limit the present disclosure, application, or uses.

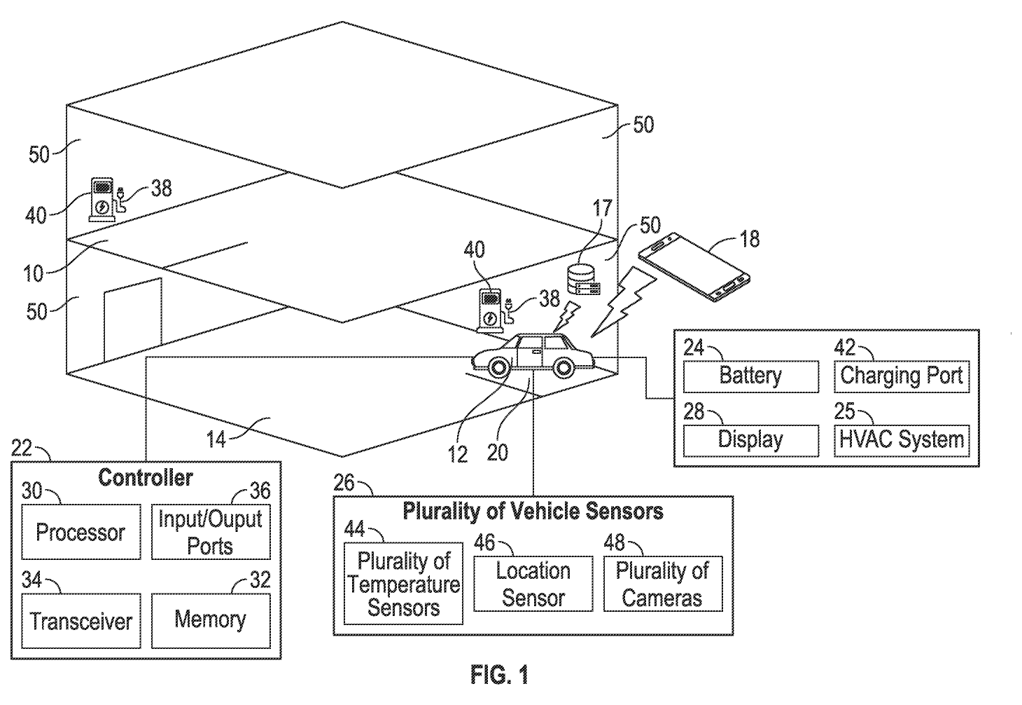

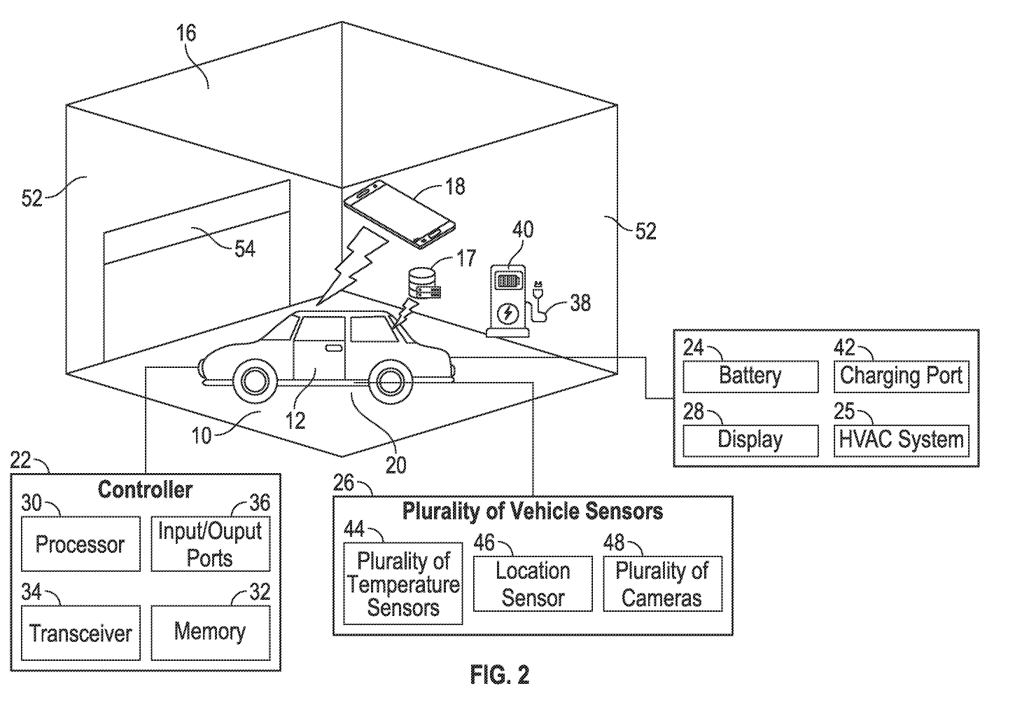

Referring to FIGS. 1 and 2, a schematic diagram of a system for determining a final location suggestion 10 for an electric vehicle 12 within one of a plurality of enclosed public structures 14 and a schematic diagram of a system for determining the final location suggestion 10 for the electric vehicle 12 within one of a plurality of private structures 16 are shown. The systems generally include an electric vehicle 12, a weather service 17, a user device 18, an initial location 20, and the final location suggestion 10.

The electric vehicle 12 is a land vehicle such as a car, truck, etc. that can be operated by a user or by an autonomous driving module. The electric vehicle 12 may have various levels of driving automation, including Level Five, Level Four, Level Three, and Level Two automation. For example, a Level Five system indicates “full automation,” referring to the full-time performance by an automated driving system of aspects of the dynamic driving task under a number of roadway and environmental conditions that can be managed by a human driver. A Level Four system indicates “high automation,” referring to the driving mode-specific performance by an automated driving system of aspects of the dynamic driving task, even if a human driver does not respond appropriately to a request to intervene. In Level Three vehicles, the vehicle systems perform the entire dynamic driving task (DDT) within the area that it is designed to do so. The vehicle operator is only expected to be responsible for the DDT-fallback when the electric vehicle 12 essentially “asks” the driver to take over if something goes wrong or the vehicle is about to leave the zone where it is able to operate. In Level Two vehicles, systems provide steering, brake/acceleration support, lane centering, and adaptive cruise control. However, even if these systems are activated, the vehicle operator at the wheel must be driving and constantly supervising the automated features. The electric vehicle 12 may include various actuator devices (not shown) used to achieve the above-described levels of automation. The actuator devices control one or more vehicle features including, but not limited to, a propulsion system, a transmission system, a steering system, and a brake system (not shown). In various embodiments, the vehicle features may further include interior and/or exterior vehicle features such as, but are not limited to, doors, a trunk, and cabin features such as air, music, lighting, etc. In the particular example provided in FIG. 1, the electric vehicle 12 includes a controller 22, a battery 24, a heating, ventilation, and air conditioning (HVAC) system 25, a plurality of electric vehicle sensors 26, and a display 28.

The controller 22 is a non-generalized, electronic control device having a preprogrammed digital computer or processor 30, a memory 32, a transceiver 34, and a plurality of input and output ports 36. The processor 30 may be a custom made or commercially available processor, a central processing unit (CPU), a graphics processing unit (GPU), an auxiliary processor among several processors associated with the controller 22, a semiconductor-based microprocessor (in the form of a microchip or chip set), a microprocessor, a combination thereof, or generally a device for executing instructions. The memory 32 is used to store data such as control logic, software applications, instructions, computer code, data, lookup tables, etc. The memory 32 includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device. Computer code includes any type of program code, including source code, object code, and executable code. The processor 30 is configured to execute the code or instructions.

The transceiver 34 is configured to wirelessly communicate with a hotspot using Wi-Fi protocols under IEEE 802.11x standards. The transceiver 34 is also configured to wirelessly communicate using cellular data communication under GSMA standards, such as SGP.02, SGP.22, SGP.32 and the like. Suitably, the electric vehicle 12 may further include an embedded universal integrated circuit card (eUICC) configured to store at least one cellular connectivity configuration profile, for example, an embedded subscriber identity module (eSIM) profile. The transceiver 34 is further configured to communicate via a personal area network (e.g., BLUETOOTH), near-field communication (NFC), and/or any additional type of radiofrequency communication.

The plurality of input and output ports 36 receive incoming data from the plurality of electric vehicle sensors 26 and communicate the incoming data to the processor 30. The plurality of input and output ports 36 also receive outgoing data from the processor 30 and communicate the outgoing data to the plurality of electric vehicle sensors 26. The plurality of input and output ports 36 are configured to wirelessly communicate with the plurality of electric vehicle sensors 26 via the transceiver 34 and are also configured to communicate with the plurality of electric vehicle sensors 26 through a Universal Serial Bus (USB) wired connection.

The controller 22 may further include one or more applications. The application is a software program configured to perform a specific function or set of functions. The applications may include one or more computer programs, software components, sets of instructions, procedures, functions, objects, classes, instances, related data, or a portion thereof adapted for implementation in a suitable computer readable program code. The applications may be stored within the memory 32 or in additional or separate memory.

The controller 22 is in electrical communication with the plurality of electric vehicle sensors 26. In an exemplary embodiment, the electrical communication is established using, for example, a CAN network, a FLEXRAY network, a local area network (e.g., WiFi, ethernet, and the like), a serial peripheral interface (SPI) network, or the like. It should be understood that various additional wired and wireless techniques and communication protocols for communicating with the controller 22 are within the scope of the present disclosure.

The battery 24 serves as the primary source of power for the electric vehicle 12 by storing electrical energy and supplying the electrical energy to an electric motor which drives the electric vehicle 12. The battery 24 may be recharged by the user connecting a charging cable 38 of a charging station 40 to a charging port 42 in the electric vehicle 12, allowing for the transfer of the electrical energy housed in the charging station 40 to the battery 24 of the electric vehicle 12. The amount of electrical energy stored within the battery 24 determines an electric vehicle range distance of the electric vehicle 12. The electric vehicle range distance is the projected distance the electric vehicle 12 can be operated based on the current amount of electrical energy within the battery 24. In a non-limiting list of examples, the electric vehicle range distance may be represented in miles (mi), feet (ft), kilometers (km), and meters (m). It should be appreciated that the electric vehicle range distance is a projection and may fluctuate based on a plurality of range conditions when the user is not operating the electric vehicle 12. The plurality of battery conditions may include equipment conditions, such as when the battery 24 engages in self-discharge, and environmental conditions, such as the temperature of the battery 24. The electric vehicle range distance may be maintained when the environmental conditions of the plurality of battery conditions are preferred.

A charging efficiency of the electric vehicle 12 is the percentage of electrical energy stored in the battery 24 relative to the amount of electrical energy discharged from the charging station 40 while the charging cable 38 is connected to the charging port 42 of the electric vehicle 12. The charging efficiency of the electric vehicle 12 ranges from 0% to 100%, and may fluctuate based on a plurality of charging conditions. In a non-limiting list of examples, the plurality of charging conditions may include equipment conditions, such as the health of the charging cable 38, a charging speed of the charging station 40, and a state of charge of the battery 24, and environmental conditions, such as the temperature of the battery 24. A maximum charging efficiency for the electric vehicle 12 is the is the highest possible percentage of electrical energy stored in the battery 24 relative to the amount of electrical energy discharged from the charging station 40 when the environmental conditions of the plurality of charging conditions are preferred.

In a non-limiting exemplary embodiment, the environmental conditions of the plurality of battery conditions and the environmental conditions of the plurality of charging conditions are preferred when the ambient temperature of the electric vehicle 12 is between a preferred vehicle temperature range of 20 degrees Celsius (the minimum acceptable vehicle temperature) and 45 degrees Celsius (the maximum acceptable vehicle temperature). It should be appreciated that the maximum acceptable vehicle temperature and the minimum acceptable vehicle temperature of the preferred vehicle temperature range may be configured, and are not strictly limited to 45 degrees Celsius and 20 degrees Celsius respectively. In another non-limiting exemplary embodiment, the environmental conditions of the plurality of battery conditions and the environmental conditions of the plurality of charging conditions are preferred when the ambient temperature of the electric vehicle 12 is within five degrees Fahrenheit of the temperature of the weather data provided by the weather service 17.

The HVAC system 25 has heating and cooling subsystems that maintain the efficiency and longevity of the battery 24 when the ambient temperature of the electric vehicle 12 is either below the minimum acceptable vehicle temperature or above the maximum acceptable vehicle temperature respectively. The HVAC system 25 maintains the efficiency and longevity of the battery 24 by maintaining the temperature of the battery 24 in the preferred vehicle temperature range despite the temperature of the electric vehicle 12 not falling within the preferred vehicle temperature range. The HVAC system 25 receives electrical energy from the battery 24, even when the electric vehicle 12 is parked. When the subsystems of the HVAC system 25 are active while the electric vehicle 12 is parked, the electric vehicle range distance and/or the charging efficiency of the electric vehicle 12 may be adversely impacted, meaning the electric vehicle range distance would be reduced and not maintained, and the charging efficiency of the electric vehicle 12 would be reduced.

The plurality of electric vehicle sensors 26 are located within the electric vehicle 12 and are used to acquire a plurality of environmental information of an environment surrounding the electric vehicle 12. In a non-limiting list of examples, the plurality of environmental information may include a temperature, a position, and an appearance of the environment surrounding the electric vehicle 12. In an exemplary embodiment, the plurality of electric vehicle sensors 26 has a plurality of temperature sensors 44, a location sensor 46, and a plurality of cameras 48.

The plurality of temperature sensors 44 are located throughout the exterior of the electric vehicle 12 and receive temperature data from the environment surrounding the electric vehicle 12. The temperature data is then communicated to the processor 30 to assist in determining whether the temperature of the initial location 20 and the final location suggestion 10 falls within an acceptable temperature range for the battery 24.

The location sensor 46 is located within the electric vehicle 12 and receives positional data of the environment surrounding the electric vehicle 12. In a non-limiting list of examples, the positional data may be represented as a set of geographic coordinates in a two-dimensional cartesian coordinate system having a latitude and a longitude, a set of geographic coordinates in a three-dimensional cartesian coordinate system having a latitude, longitude, and altitude, a set of Universal Transverse Mercator (UTM) coordinates having an easting coordinate and a northing coordinate, a set of State Plane Coordinates (SPC), and a set of polar coordinates. The positional data is then communicated to the processor 30 to assist in determining the location of the electric vehicle 12.

The plurality of cameras 48 are located throughout the exterior of the electric vehicle 12 and receive visual data from the environment surrounding the electric vehicle 12. The visual data is then communicated to the processor 30 to assist in determining whether the environment surrounding the electric vehicle 12 is one of a plurality of private structures 16 associated with the electric vehicle 12 or is one of the plurality of enclosed public structures 14 using a machine-learning algorithm.

The display 28 is a screen that is located within the electric vehicle 12 that has a human-machine interface that presents the electric vehicle range distance, the charging efficiency of the electric vehicle 12, and the temperature data, positional data, and visual data received by the plurality of electric vehicle sensors 26. The display 28 also allows the user to configure the electric vehicle 12, and run the applications included in the controller 22. The display 28 is an optional feature, meaning the display 28 is not required for the proper use or functionality of the electric vehicle 12, the plurality of electric vehicle sensors 26, or any other part of the systems.

The weather service 17 is a service used to communicate weather data of the initial location 20, the plurality of potential final location suggestions, and the final location suggestion 10, to the processor 30. In an exemplary embodiment, the weather service 17 is a computerized database that may communicate the weather data via satellite, a cellular network, or a local area network. The weather data may have, in a non-limiting list of examples, information regarding the temperature, humidity, wind chill, wind speed, and precipitation of the initial location 20, the plurality of potential final location suggestions, and the final location suggestion 10.

The user device 18 is a device owned by the user that receives incoming data from the transceiver 34. The user device 18 comprises a screen for display purposes, such as displaying the temperature data, the positional data, and the visual data, and a human-machine interface to allow the user to interact with prompts received from the processor 30 regarding the environment of the initial location 20 from the user device 18. While the user device 18 is illustrated as a mobile phone for the purposes of this disclosure, it should be appreciated that the user device 18 may take various forms. For example, the user device 18 may be a tablet, a smart watch, a laptop, or a desktop computer.

The initial location 20 is a position where the electric vehicle 12 is parked by the user once the user has ceased operating the electric vehicle 12. The initial location may have a charging station 40 when the user decides to charge the electric vehicle 12. In a non-limiting list of examples, the initial location 20 may be one of a plurality of private structures 16 associated with the electric vehicle 12, one of the plurality of enclosed public structures 14, a parking spot on a roadway, or an arbitrary location in an outdoor area such as a field or a forest.

The final location suggestion 10 for the electric vehicle 12 is a position determined by the processor 30 that would maintain the electric vehicle range distance and/or allow for a greater charging efficiency of the electric vehicle 12 relative to the charging efficiency of the vehicle at the initial location 20 up to the maximum charging efficiency while charging the electric vehicle 12. The determination of the final location suggestion 10 is made based on a plurality of preferred final location qualities of a plurality of potential final location suggestions. The final location suggestion 10 may have a charging station 40 when the user decides to charge the electric vehicle 12.

In a non-limiting list of examples, the plurality of preferred final location qualities may include a preferred ambient temperature of the final location suggestion 10, a larger number of structure sides compared to the initial location 20, and that the environment of the final location suggestion 10 would allow the HVAC system 25 to consume less electrical energy from the battery 24 while the electric vehicle 12 is parked compared to the initial location 20. In a non-limiting exemplary embodiment, the ambient temperature of the final location suggestion 10 is preferred when the ambient temperature is between a preferred environmental temperature range of 20 degrees Celsius (the minimum acceptable environmental temperature) and 45 degrees Celsius (the maximum acceptable environmental temperature). It should be appreciated that the maximum acceptable environmental temperature and the minimum acceptable environmental temperature of the preferred environmental temperature range may be configured, and are not strictly limited to 45 degrees Celsius and 20 degrees Celsius respectively. In another non-limiting exemplary embodiment, the environmental conditions of the plurality of battery conditions and the environmental conditions of the plurality of charging conditions are preferred when the ambient temperature of the initial location 20 is within five degrees Fahrenheit of the weather data provided by the weather service 17.

In a non-limiting exemplary embodiment where the electric vehicle 12 is parked in one of the plurality of enclosed public structures 14, the plurality of preferred final location qualities may include the final location suggestion 10 having a larger number of a plurality of public structure sides 50 observable by the plurality of cameras 48 compared to the plurality of public structure sides 50 observable by the plurality of cameras 48 at the initial location 20. In a non-limiting exemplary embodiment where the electric vehicle 12 is parked in one of the plurality of private structures 16, the plurality of preferred final location qualities may include the final location suggestion 10 having a larger number of a plurality of private structure sides 52 observable by the plurality of cameras 48 compared to the plurality of private structure sides 52 observable by the plurality of cameras 48 at the initial location 20.

Referring to FIG. 1, the plurality of enclosed public structures 14 are enclosed structures that may house the electric vehicle 12 while the electric vehicle 12 is parked, but that the user does not have ownership or control over. An enclosed structure may be determined to be one of the plurality of enclosed public structures 14 when each respective structure is determined to not be one of the plurality of private structures 16 associated with the electric vehicle 12. The processor 30 determines that the structure the electric vehicle 12 is within is enclosed based on the positional data and the visual data received from the plurality of electric vehicle sensors 26. For the processor 30 to determine that the structure the electric vehicle 12 is within is enclosed based on the positional data, the positional data may include a plurality of qualities of the structure at the position, one of the plurality of qualities being that the structure is enclosed. For the processor 30 to determine that the structure the electric vehicle 12 is within is enclosed based on the visual data, the plurality of cameras 48 observe the plurality of public structure sides 50 that surround the electric vehicle 12. In a non-limiting list of examples, one of the plurality of enclosed public structures 14 may be a parking spot in a parking lot or a parking spot in a public parking structure.

In an exemplary embodiment where the initial location 20 of the electric vehicle 12 is in one of the plurality of enclosed public structures 14, the plurality of potential final location suggestions are positions within the respective enclosed public structure that are not the initial location 20 where the electric vehicle 12 may be parked. In a non-limiting list of examples, the plurality of potential final location suggestions may be a position farther away from an entrance of the respective enclosed public structure compared to the initial location 20, may be a position where the plurality of cameras would observe a larger number of the plurality of public structure sides 50 compared to the initial location 20, or when the respective enclosed public structure is made up of several levels, a position on a different level from the initial location 20.

The final location suggestion 10 is selected from one of the plurality of potential final location suggestions having the plurality of preferred final location qualities. It should be appreciated that the final location suggestion 10 need not have all the plurality of preferred final location qualities, merely that the final location suggestion 10 have at least as many of the plurality of preferred final location qualities compared to the initial location 20. It should further be appreciated that the final location suggestion 10 along with the plurality of preferred final location qualities of the final location suggestion 10 may be recorded in the memory 32 of the controller 22 to be referenced for a future final location suggestion when returning to the respective enclosed public structure. It should also be appreciated that when the electric vehicle 12 is charging, one of the plurality of preferred final location qualities may include accessibility to a charging station for the continued charging of the electric vehicle 12.

It should be appreciated that the final location suggestion 10 is a suggestion of a location where the user may park the electric vehicle 12 and that the user may choose to keep the electric vehicle 12 parked at the initial location 20. It should also be appreciated that when the initial location 20 is the only position within the respective enclosed public structure in which the electric vehicle 12 is parked, the processor 30 does not determine a final location suggestion 10.

Referring to FIG. 2, the plurality of private structures 16 associated with the electric vehicle 12 are enclosed structures that the user has ownership or control over that may house the electric vehicle 12 while the electric vehicle 12 is parked. In a non-limiting exemplary embodiment, each of the plurality of private structures 16 has an associated position stored within the memory 32 which can be retrieved by the processor 30 and compared to the positional data measured by the location sensor 46 in order to determine whether the location of the electric vehicle 12 is within one of the plurality of private structures 16. In another non-limiting exemplary embodiment, the transceiver 34 receives a signal from a Wi-Fi router associated with a respective private structure. Each of the plurality of private structures 16 has the plurality of private structure sides 52, which define the enclosed space of each of the plurality of private structures 16. At least one of the plurality of private structure sides 52 may have a structure door 54 having a closed state (not shown) and an open state (shown). When the structure door 54 is in the closed state, the respective private structure is fully enclosed. When the structure door 54 is in the open state, the respective private structure is not fully enclosed. In an exemplary embodiment where the plurality of private structure sides 52 has more than one structure door, the respective private structure is fully enclosed when each structure door is in the closed state.

In an exemplary embodiment where the initial location 20 of the electric vehicle 12 is one of the plurality of private structures 16, the plurality of potential final location suggestions are positions within the respective private structure that are not the initial location 20 where the electric vehicle 12 may be parked. In a non-limiting list of examples, the plurality of potential final location suggestions may be a position farther away from an entrance of the respective private structure compared to the initial location 20, may be a position where the plurality of cameras would observe a larger number of the plurality of private structure sides 52 compared to the initial location 20, or when the respective private structure is made up of several levels, a position on a different level from the initial location 20. The final location suggestion 10 is selected from one of the plurality of potential final location suggestions having the plurality of preferred final location qualities. It should be appreciated that the final location suggestion 10 need not have all the plurality of preferred final location qualities, merely that the final location suggestion 10 have at least as many of the plurality of preferred final location qualities compared to the initial location 20. It should further be appreciated that the final location suggestion 10 along with the plurality of preferred final location qualities of the final location suggestion 10 may be recorded in the memory 32 of the controller 22 to be referenced for a future final location suggestion when returning to the respective private structure.

It should be appreciated that the final location suggestion 10 is a suggestion of a location where the user may park the electric vehicle 12 and that the user may choose to keep the electric vehicle 12 parked at the initial location 20. It should also be appreciated that when the initial location 20 is the only position within the respective private structure in which the electric vehicle 12 is parked, the processor 30 does not determine a final location suggestion 10. In the exemplary embodiment where the initial location 20 is the only position within the respective private structure in which the electric vehicle 12 is parked, when the initial location 20 does not have the plurality of preferred final location qualities and the processor 30 determines the structure door 54 is in the open state based on the visual data, the processor 30 may notify the user that the structure door 54 is in the open state via the display 28 and/or the user device 18.

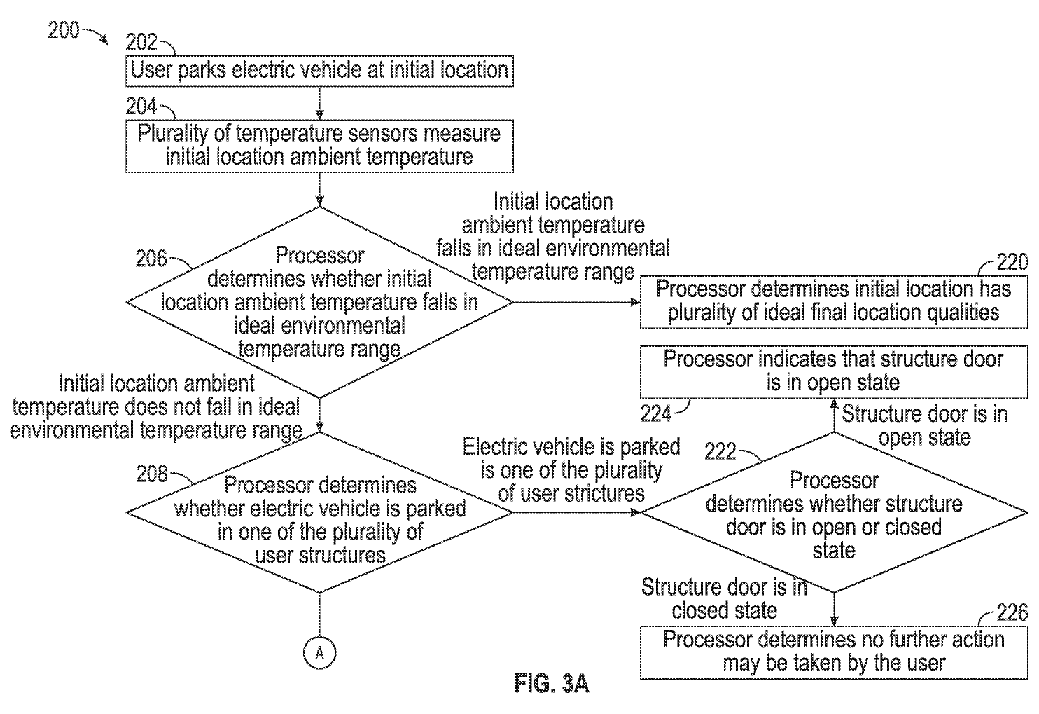

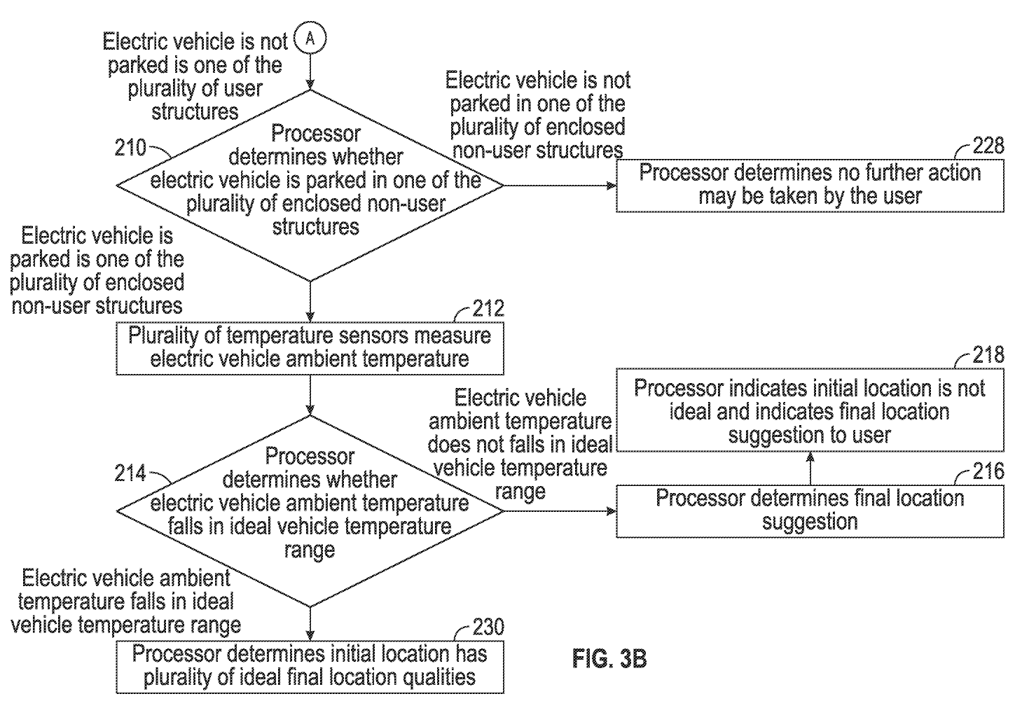

Referring to FIGS. 3A and 3B, a flowchart of a method for determining the final location suggestion 10 for the electric vehicle 12 is generally indicated by reference number 200. The method 200 begins at step 202, where a user parks the electric vehicle 12 at the initial location 20. The method 200 then proceeds to step 204.

At step 204, the plurality of temperature sensors 44 measure the ambient temperature of the initial location 20. The method 200 then proceeds to step 206.

At step 206, the processor 30 determines whether the ambient temperature of the initial location 20 falls between the maximum temperature and the minimum temperature of the preferred environment temperature range. When the ambient temperature of the initial location 20 falls outside of the preferred environment temperature range, the method 200 then proceeds to step 208.

At step 208, the processor 30 determines whether the electric vehicle 12 is parked within one of the plurality of private structures 16 based on the positional data and the visual data received by the location sensor 46 and the plurality of cameras 48 respectively. When the processor 30 determines that the electric vehicle 12 is not parked within one of the plurality of private structures 16, the method 200 then proceeds to step 210.

At step 210, the processor 30 determines whether the electric vehicle 12 is parked within one of the plurality of enclosed public structures based on the positional data and the visual data received by the location sensor 46 and the plurality of cameras 48 respectively. When the processor 30 determines that the electric vehicle 12 is parked within one of the plurality of enclosed public structures 14, the method 200 then proceeds to step 212.

At step 212, the plurality of temperature sensors 44 measure the ambient temperature of the electric vehicle 12. The method 200 then proceeds to step 214.

At step 214, the processor 30 determines whether the ambient temperature of the electric vehicle 12 falls between the maximum acceptable vehicle temperature and the minimum acceptable vehicle temperature of the preferred vehicle temperature range. When the ambient temperature of the electric vehicle 12 falls outside of the preferred vehicle temperature range, the method 200 then proceeds to step 216.

At step 216, the processor 30 determines the final location suggestion 10 for the electric vehicle 12 based on the plurality of preferred final location qualities of the plurality of potential final location suggestions. The method 200 then proceeds to step 218.

At step 218, the processor 30 indicates to the user via the display 28 and/or the user device 18 that the ambient temperature of the initial location 20 and the ambient temperature of the electric vehicle 12 are not preferred for maintaining the electric vehicle range distance and indicates the final location suggestion 10. In an exemplary embodiment where the electric vehicle 12 is charging, the processor 30 also indicates to the user via the display 28 and/or the user device 18 that the ambient temperature of the initial location 20 and the ambient temperature of the electric vehicle 12 are not preferred for achieving a greater charging efficiency of the electric vehicle 12.

Returning to step 206, when the ambient temperature of the initial location 20 falls inside of the preferred environment temperature range, the method 200 then proceeds to step 220.

At step 220, the processor 30 determines the initial location 20 has the plurality of preferred final location qualities to maintain the electric vehicle range distance. In an exemplary embodiment where the electric vehicle 12 is charging, the processor 30 also determines the initial location 20 has the plurality of preferred final location qualities to achieve a greater charging efficiency of the electric vehicle 12.

Returning to step 208, when the processor 30 determines that the electric vehicle 12 is parked within one of the plurality of private structures 16, the method 200 then proceeds to step 222.

At step 222, the processor 30 determines whether the structure door 54 is in the open state or the closed state. When the structure door 54 is in the open state, the method 200 then proceeds to step 224.

At step 224, the processor 30 indicates to the user via the user device 18 that the structure door 54 is in the open state and that setting the structure door 54 to the closed state will maintain the electric vehicle range distance. In an exemplary embodiment where the electric vehicle 12 is charging, the processor 30 also indicates to the user via the user device 18 that setting the structure door 54 to the closed state is preferred for achieving a greater charging efficiency of the electric vehicle 12.

Returning to step 222, when the structure door 54 is in the closed state, the method 200 then proceeds to step 226.

At step 226, the processor 30 determines that no further action by the user can place the electric vehicle 12 in an environment that further maintains the electric vehicle range distance. In an exemplary embodiment where the electric vehicle 12 is charging, the processor 30 also determines that no further action by the user can place the electric vehicle 12 in an environment that can achieve a greater charging efficiency for the electric vehicle 12.

Returning to step 210, when the processor 30 determines that the electric vehicle 12 is not parked within one of the plurality of enclosed public structures 14, the method 200 then proceeds to step 228.

At step 228, the processor 30 determines that no further action by the user can place the electric vehicle 12 in an environment that further maintains the electric vehicle range distance. In an exemplary embodiment where the electric vehicle 12 is charging, the processor 30 also determines that no further action by the user can place the electric vehicle 12 in an environment that can achieve a greater charging efficiency for the electric vehicle 12.

Returning to step 214, when the ambient temperature of the electric vehicle 12 falls inside of the preferred vehicle temperature range, the method 200 then proceeds to step 230.

At step 230, the processor 30 determines the initial location 20 has the plurality of preferred final location qualities to maintain the electric vehicle range distance. In an exemplary embodiment where the electric vehicle 12 is charging, the processor 30 also determines the initial location 20 has the plurality of preferred final location qualities to achieve a greater charging efficiency of the electric vehicle 12.

A determination of a final location suggestion 10 of the present disclosure offers several advantages. One such advantage includes indicating to the user that the environment of the initial location 20 may adversely impact the electric vehicle range distance of the electric vehicle and providing the final location suggestion 10 to the user for the electric vehicle 12 to be parked that has an environment that maintains the electric vehicle range distance relative to the environment of the initial location 20. Another advantage includes indicating to the user that the environment of the initial location 20 may adversely impact the charging efficiency of the electric vehicle 12 while the electric vehicle 12 is charging and providing the final location suggestion 10 to the user for the electric vehicle 12 to be parked that has an environment that achieves a greater charging efficiency for the electric vehicle 12 relative to the environment of the initial location 20 up to the maximum charging efficiency.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method for providing a charging location for a parked electric vehicle, the method comprising:
measuring a current environmental temperature of a first location of the parked electric vehicle using a plurality of vehicle sensors in the parked electric vehicle;
comparing the current environmental temperature to a minimum acceptable environmental temperature and a maximum acceptable environmental temperature of an electric vehicle battery in the parked electric vehicle;
determining the current environmental temperature of the first location is one of less than the minimum acceptable environmental temperature and is higher than the maximum acceptable environmental temperature;
collecting a plurality of positional and visual data of the first location using the plurality of vehicle sensors;
determining the first location is not one of a plurality of private structures having a plurality of private structure sides associated with the parked electric vehicle based on the plurality of positional and visual data;
determining the first location is one of a plurality of enclosed public structures based on the plurality of positional and visual data;
measuring a vehicle temperature of the parked electric vehicle using the plurality of vehicle sensors;
comparing the vehicle temperature to a minimum acceptable vehicle temperature and a maximum acceptable vehicle temperature of the electric vehicle battery;
determining the vehicle temperature of the first location is one of less than the minimum acceptable vehicle temperature and is higher than the maximum acceptable vehicle temperature;
determining the first location of the parked electric vehicle is not a preferred location for the parked electric vehicle based on the determination that current environmental temperature of the first location is one of lower than the minimum acceptable environmental temperature and is higher than the maximum acceptable environmental temperature, the determination that the first location is not a private structure associated with the parked electric vehicle, the determination that the first location is a public structure, and the determination that the vehicle temperature of the parked electric vehicle is one of less than the minimum acceptable vehicle temperature and higher than the maximum acceptable vehicle temperature;
determining a second location is the charging location for the parked electric vehicle using the plurality of vehicle sensors; and
providing the charging location for the parked electric vehicle.

2. The method of claim 1, wherein measuring the current environmental temperature of the first location of the parked electric vehicle using the plurality of vehicle sensors further comprises measuring the current environmental temperature of the first location of the parked electric vehicle using the plurality of vehicle sensors having a plurality of temperature sensors.

3. The method of claim 1, wherein comparing the current environmental temperature to the minimum acceptable environmental temperature and the maximum acceptable environmental temperature of the electric vehicle battery further comprises comparing the current environmental temperature to the minimum acceptable environmental temperature when the minimum acceptable environmental temperature is 20 degrees Celsius and comparing the current environmental temperature to the maximum acceptable environmental temperature when the maximum acceptable environmental temperature is 45 degrees Celsius.

4. The method of claim 1, wherein collecting the plurality of positional and visual data of the first location using the plurality of vehicle sensors further comprises collecting the plurality of positional and visual data of the first location using the plurality of vehicle sensors having a location sensor and a plurality of cameras.

5. The method of claim 4 further comprising determining the first location is similar to a location of one of the plurality of private structures associated with the parked electric vehicle when the location sensor identify the first location as being similar to a location of one of the plurality of private structures associated with the parked electric vehicle.

6. The method of claim 4 further comprising determining the first location is similar to one of the plurality of private structures associated with the parked electric vehicle when the plurality of cameras identify the first location as belonging to one of the plurality of private structures associated with the parked electric vehicle.

7. The method of claim 4 further comprising determining that the one of the plurality of private structures associated with the parked electric vehicle is not enclosed based on determining at least one of the plurality of private structure sides has not been identified by the plurality of cameras wherein the at least one of the plurality of private structure sides that has not been identified has a structure door having a closed state and an open state.

8. The method of claim 7 further comprising indicating that the structure door is in the open state and that setting the structure door to the closed state will maintain a maximum charging efficiency of the parked electric vehicle via a human-machine interface connected to the parked electric vehicle while charging the parked electric vehicle.

9. The method of claim 4 further comprising determining that the one of the plurality of private structures associated with the parked electric vehicle is enclosed based on determining that each of the plurality of private structure sides has been identified by the plurality of cameras.

10. The method of claim 4, wherein determining the first location is not one of the plurality of private structures associated with the parked electric vehicle based on the plurality of positional and visual data further comprises determining that the first location is not similar to a location of one of the plurality of private structures associated with the parked electric vehicle when the location sensor do not identify the first location as being similar to a location of one of the plurality of private structures associated with the parked electric vehicle.

11. The method of claim 4, wherein determining the first location is one of the plurality of enclosed public structures based on the plurality of positional and visual data further comprises determining that the first location is not similar to a location of one of the plurality of private structures associated with the parked electric vehicle when the location sensor do not identify the first location as being similar to a location of one of the plurality of private structures associated with the parked electric vehicle and determining that the first location is enclosed when the location sensor identify the first location as being one of a plurality of enclosed public structures or determining that each of a plurality of public structure sides has been identified by the plurality of cameras.

12. The method of claim 1, wherein comparing the vehicle temperature to the minimum acceptable vehicle temperature and the maximum acceptable vehicle temperature of the electric vehicle battery further comprises comparing the vehicle temperature to the minimum acceptable vehicle temperature when the minimum acceptable vehicle temperature is 20 degrees Celsius and comparing the vehicle temperature to the maximum acceptable vehicle temperature when the maximum acceptable vehicle temperature is 45 degrees Celsius.

13. The method of claim 1, wherein determining the first location of the parked electric vehicle is not the preferred location for the parked electric vehicle further comprises indicating that the current environmental temperature and the vehicle temperature are not preferred conditions for maintaining an electric vehicle range distance of the parked electric vehicle via a human-machine interface connected to the parked electric vehicle.

14. The method of claim 1, wherein determining the first location of the parked electric vehicle is not a preferred final location for the parked electric vehicle further comprises indicating that the current environmental temperature and the vehicle temperature are not conditions for maintaining a maximum charging efficiency of the parked electric vehicle via a human-machine interface connected to the parked electric vehicle while charging the parked electric vehicle.

15. The method of claim 1, wherein determining the charging location using the plurality of vehicle sensors further comprises determining the charging location based on a position of the charging location within one of the plurality of public enclosed structures using the plurality of vehicle sensors.

16. The method of claim 15 further comprising receiving a final location ambient temperature of the position of the charging location from a cloud interface connected to the parked electric vehicle.

17. The method of claim 16 further comprising comparing the current environmental temperature to the final location ambient temperature.

18. The method of claim 17 further comprising determining the charging location based on a determination that the current environmental temperature is within five degrees Fahrenheit of the final location ambient temperature.

19. A method for indicating that setting a structure door of one of a plurality of private structures having a closed state and an open state to the closed state can maintain a maximum charging efficiency of a parked electric vehicle, the method comprising:
measuring a current environmental temperature of a first location of the parked electric vehicle using a plurality of vehicle sensors in the parked electric vehicle;
comparing the current environmental temperature to a minimum acceptable environmental temperature and a maximum acceptable environmental temperature of an electric vehicle battery in the parked electric vehicle;
determining the current environmental temperature of the first location is either lower than the minimum acceptable environmental temperature or is higher than the maximum acceptable environmental temperature;
collecting a plurality of positional and visual data of the first location using the plurality of vehicle sensors wherein collecting the plurality of positional and visual data of the first location using the plurality of vehicle sensors comprises collecting the plurality of positional and visual data of the first location using the plurality of vehicle sensors having a location sensor and a plurality of cameras;
determining the first location is similar to a location of one of the plurality of private structures associated with the parked electric vehicle when the location sensor identify the first location as being similar to a location of one of the plurality of private structures associated with the parked electric vehicle;
determining that the structure door is in the open state based on the structure door not being identified as being in the closed state by the plurality of cameras; and
indicating that setting the structure door to the closed state can maintain the maximum charging efficiency of the parked electric vehicle via a human-machine interface connected to the parked electric vehicle.

20. A method for providing a second location for a parked electric vehicle that maintains an electric vehicle range distance of the parked electric vehicle, the method comprising:
measuring a current environmental temperature of a first location of the parked electric vehicle using a plurality of temperature sensors in the parked electric vehicle;
comparing the current environmental temperature to a minimum acceptable environmental temperature and a maximum acceptable environmental temperature of an electric vehicle battery in the parked electric vehicle wherein the minimum acceptable environmental temperature is 20 degrees Celsius, the maximum acceptable environmental temperature is 45 degrees Celsius, and the electric vehicle battery powers the parked electric vehicle for the electric vehicle range distance;
determining the current environmental temperature of the first location is either lower than the minimum acceptable environmental temperature or is higher than the maximum acceptable environmental temperature;
collecting a plurality of positional and visual data of the first location using a location sensor and a plurality of cameras in the parked electric vehicle;
determining the first location is not one of a plurality of private structures associated with the parked electric vehicle based on the plurality of positional and visual data;
determining the first location is one of a plurality of enclosed public structures based on the plurality of positional and visual data by determining that the first location is not similar to a location of one of the plurality of private structures associated with the parked electric vehicle when the location sensor do not identify the first location as being similar to a location of one of the plurality of private structures associated with the parked electric vehicle and determining that the first location is enclosed when the location sensor identify the first location as being one of a plurality of enclosed locations or determining that each of a plurality of public structure sides has been identified by the plurality of cameras;
measuring a vehicle temperature of the parked electric vehicle using the plurality of temperature sensors;
comparing the vehicle temperature to a minimum acceptable vehicle temperature and a maximum acceptable vehicle temperature of the electric vehicle battery wherein the minimum acceptable vehicle temperature is 20 degrees Celsius and the maximum acceptable vehicle temperature is 45 degrees Celsius;
determining the vehicle temperature of the parked electric vehicle is either lower than the minimum acceptable vehicle temperature or is higher than the maximum acceptable vehicle temperature;
determining the first location of the parked electric vehicle does not maintain the electric vehicle range distance based on the determination that current environmental temperature of the first location is either lower than the minimum acceptable environmental temperature or is higher than the maximum acceptable environmental temperature, the determination that the first location is not one of the plurality of private structures associated with the parked electric vehicle, the determination that the first location is an enclosed public structure, and the determination that the vehicle temperature of the first location is either lower than the minimum acceptable vehicle temperature or is higher than the maximum acceptable vehicle temperature;
indicating the current environmental temperature and the vehicle temperature are not preferred conditions for maintaining the electric vehicle range distance via a human-machine interface connected to the parked electric vehicle;
determining the second location for the parked electric vehicle that maintains the electric vehicle range distance using the location sensor and the plurality of cameras based on a position of the second location within one of the plurality of public enclosed structures and one of a final location environmental temperature of the second location within the public enclosed structure; and
providing the second location for the parked electric vehicle that maintains the electric vehicle range distance via the human-machine interface connected to the parked electric vehicle.
